(19) United States
(12) Patent Application Publication
(10) Pub. No.: US 2009/0176582 A1
(43) Pub. Date: Jul. 9, 2009

(54) Gaming machine with belly located media dispenser

(76) Inventors: Joseph W. Cole, North Las Vegas, NV (US); Edward H. Comfort, North Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/006,661

(22) Filed: Jan. 3, 2008

(51) Int. Cl. A63F 13/08; A63F 13/02

(52) U.S. Cl. 463/46; 463/47

(57) ABSTRACT

A gaming machine has a media dispenser, such as a ticket printer. The media dispenser is located in a belly portion of the gaming machine below a console portion. The media dispenser may be located in front of a cabinet portion of the gaming machine and behind a door thereof. The media dispenser preferably extends horizontally through the gaming machine. A portion of the media dispenser may be located in front of a currency box of a currency acceptor of the machine. The location of the media dispenser simplifies the configuration of the gaming machine as well as access to the media dispenser.

### FIELD OF THE INVENTION

The present invention relates to gaming machines and, more particularly, the configuration of the components of such machines.

### BACKGROUND OF THE INVENTION

Wager-based gaming machines have become very complex machines. In the past, these machines were relatively simple mechanical devices which had physical reels which were rotated via force applied to a handle. Later, the gaming machines became electronically controlled. For example, the physical reels were rotated by electric motors which were operated in response to an electrical signal generated by a player's pull of the handle.

In addition, these machines have been modified to include a wide variety of features. For example, electronically controlled slot or video type gaming machines may include multiple video displays. They may also include electronic bill and coin validators, ticket printers, player card readers and a host of other devices.

At the same time, pressure exists to reduce the size of the machines. In the past, a casino might only have a few gaming machines. Today, in order to offer players with the greatest variety of games, casinos may have hundreds or thousands of gaming machines. However, given the limited amount of space within a casino and the expense associated with that space, it is desirable for the machines to have a small footprint so as to maximize the number of machines that can be located in a given space.

As the size of the machine decreases while the number of components increases, problems arise. In some instances, there is insufficient room to fit all of the components. In other instances, the components are packed into the machine, but their configuration hinders servicing of the machine in a quick and efficient manner.

For example, U.S. Pat. No. 7,125,335 illustrates one configuration which is relatively common in the prior art. As illustrated in FIG. 1 herein, which corresponds to FIG. 8 of that patent, the gaming machine (42) has a cabinet (220) housing a plurality of components. Speakers (246), an aroma dispenser (250) and a card reader (244) are associated with a top portion of the gaming machine (42). A display (222) is located in a middle portion of the machine. Various buttons (224,226,228), a ticket printer (110), a coin acceptor (240), a bill acceptor (242) and other components are located at a console portion of the machine above a belly portion between the console and a coin tray (254) at the bottom of the machine.

While this machine has a generally traditional configuration, it suffers from a number of drawbacks. For example, the card reader (244) is located high on the machine. This is beneficial because it keeps that component away from the middle of the machine where a large number of other components are located, where there is a lack of space. On the other hand, the card reader (244) is then located high above the player in a less desirable location from the player's perspective. Further, the ticket printer (110), including a cartridge for blank tickets, extends into the crowded space behind the console. In this configuration, the ticket printer, including the print head and cartridge, are difficult to access, making the frequently required services of the ticket printer more difficult and time consuming.

An improved gaming machine component configuration is desired.

### SUMMARY OF THE INVENTION

One aspect of the invention is a gaming machine configuration and, more particularly, a configuration of components of the gaming machine.

In one embodiment, the gaming machine has a cabinet comprising a housing and a door located at a front of the housing. The gaming machine has a top portion, a console portion below the top portion, and a belly portion below the console portion.

A media dispenser is located in the belly portion of the gaming machine. In one embodiment, the media dispenser is located in front of the housing portion of the gaming machine, and behind the door.

In one embodiment, the media dispenser extends generally horizontally within the gaming machine. The media dispenser may be configured so that a lengthwise dimension of the media dispenser extends along an axis through the gaming machine from side to side.

The media dispenser may comprise a media generator, a media transport, and a media outlet. The media generator may comprise a housing for media and a printing device. The media transport may comprise a conduit which defines a slot through which the media is transported from the media generator to the media outlet. The media outlet may comprise a slot located in the door of the gaming machine.

In one embodiment, the gaming machine includes a currency acceptor. At least a portion of the media dispenser is located in front of a portion of the currency acceptor. In one embodiment, a portion of the media transport is located in front of a currency box of the currency acceptor. The media outlet of the media dispenser may be located below, but in general vertical alignment with, a currency input or slot to the currency acceptor.

The configuration of the gaming machine, including the arrangement of the media dispenser, has particular advantages. Among others, the configuration dispenser simplifies the configuration of the gaming machine as well as access to the media dispenser.

Further objects, features, and advantages of the present invention over the prior art will become apparent from the detailed description of the drawings which follows, when considered with the attached figures.

### DESCRIPTION OF THE DRAWINGS

FIG. 1 illustrates a configuration of a gaming machine in accordance with the prior art;

FIG. 2 is a perspective view of a configuration of a gaming machine in accordance with an embodiment of the invention;

FIG. 3 is a side view of the gaming machine illustrated in FIG. 1;

FIG. 4 is a front view of the gaming machine illustrated in FIG. 1;

FIG. 5 is an enlarged top view of a media dispenser portion of the gaming machine illustrated in FIG. 1;

FIG. 6 is a side view of the media dispenser illustrated in FIG. 5;

FIG. 7 is a front view of the media dispenser illustrated in FIG. 5;

FIG. 8 is a side view of a gaming machine in accordance with another embodiment of the invention;

FIG. 9 is a front view of the gaming machine illustrated in FIG. 8;

FIG. 10 is an enlarged top view of a media dispenser portion of the gaming machine illustrated in FIG. 8;

FIG. 11 is a side view of the media dispenser illustrated in FIG. 10; and

FIG. 12 is a front view of the media dispenser illustrated in FIG. 10.

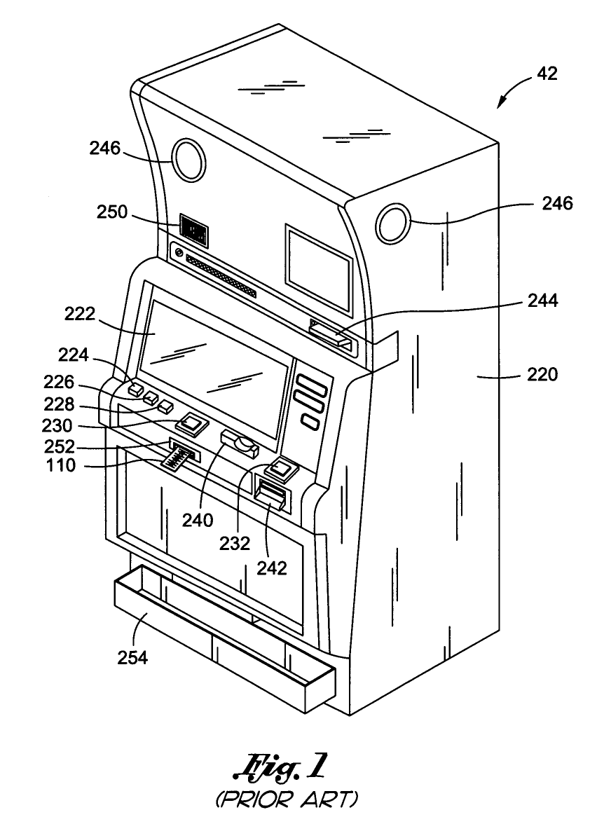

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

One embodiment of the invention is a configuration of a gaming machine and, more particularly, an arrangement of one or more components thereof. In general, the invention is a gaming machine having a media dispenser, such as a ticket printer, located in a belly portion thereof. In a preferred embodiment, at least a portion of the media dispenser is located in front of a currency acceptor.

FIG. 2 illustrates a gaming machine 20 in accordance with one embodiment of the invention. The gaming machine 20 has a cabinet which supports and/or houses various components. In one embodiment, the cabinet comprises a housing 22 and at least one door 24. The cabinet, including the housing 22 and door 24, may have a variety of shapes and configurations and may be constructed from a number of materials and in a number of ways.

In one embodiment, the gaming machine 20 has an “upright” configuration as is generally known in the art. In this configuration, the housing 22 has a pair of opposing, generally vertically extending sides, an opposing top and bottom, and a rear or back. In one embodiment, the housing 22 defines a generally open front. A door 24 is located at the front of the housing 22. Preferably, the door 24 is movable relative to the housing 22, such as by mounting to one or more hinges, to allow the door 24 to be moved between a generally closed position (covering the otherwise open front of the housing 22) or an open position (allowing access into the housing 22).

The size of the door 24 may vary, and in one embodiment the door 24 need not comprise the entire front of the gaming machine 20. For example, the housing 22 might define a generally closed top portion of the gaming machine 20 at the front thereof, while the door 24 might only define a lower portion of the front of the gaming machine 20.

In other embodiments, the front of the gaming machine 20 may be generally closed with limited access provided by smaller panels or doors, rather than by having a single large door control access to all or a substantial portion of the front of the gaming machine 20.

The gaming machine 20 may have a variety of components. Preferably, the gaming machine 20 includes at least one display 26. The display 26 may be of a variety of types, such as spinning reels, a video display (CRT, flat panel, etc.). Of course, the gaming machine 20 may include more than one display 26.

In one embodiment, the display 26 may be mounted to the door 26. In other embodiments, the display 26 may be mounted to or located within the housing 22.

As illustrated, the display 26 is located at a top portion of the gaming machine 20. Below the display 26 and the top portion of the gaming machine is a console or console portion 28. The console 28 is preferably located in a middle portion of the gaming machine 20 between its top and bottom. As illustrated, the console 28 may extend outwardly towards a player. The console 28 may be part of the door 24 (as illustrated), or may be a portion of the housing 22. The console 28 preferably supports one or more components of the gaming machine 20, such as one or more buttons 30 or other player input devices.

In one embodiment, the gaming machine 20 may include a currency acceptor 34. Preferably, the currency acceptor 34 is configured to receive paper currency or “bills”, validate and store that currency. In one embodiment, a slot is defined in the console 28 through which currency may be inserted into a corresponding slot of the currency acceptor 34. As best illustrated in FIG. 3, the currency acceptor 34 may define a currency validator head 50 and a currency or bill box or container 52 in which the currency is stored. The bill box 52 is preferably located in the interior of the gaming machine 20 behind the door 24. As illustrated, the validator head 50 portion of the currency acceptor 34 preferably aligns with the slot in the console 28. The bill box 52 extends down from the console 28 into a belly portion 36 of the gaming machine 20.

Referring again to FIG. 2, the belly portion or area 36 of the gaming machine 20 is located beneath the console 30 and above a bottom of the gaming machine 20. In one embodiment, a belly glass 38 may be located at the belly portion 36 of the gaming machine 20. The belly glass 38 might bear artwork, the name of the gaming machine or the like. The belly glass 38 might be interchangeable and might be back-lit.

In one embodiment, a portion of the belly portion 36 of the door 24 may be defined by a door or panel 40. In the embodiment in which the door 24 is located at the front of the gaming machine 20, the panel 40 may be mounted to the door 24, and be movable relative to the door 24. In this manner, the panel 40 might provide sub-access to the interior of the gaming machine 20 without having to open the door. In such instance, the panel 40 (or panels, depending on the configuration) may be controlled with one or more locks to selectively allow or prevent their being opened.

It will be understood that the terms “belly portion”, “top portion” and the like as used to refer to the gaming machine 20 may refer to both an area of the gaming machine 20, but the corresponding portions thereof, such as the same portion of the cabinet (including the door and/or housing, as well as an interior portion of the gaming machine 20). For example, the belly portion 36 of the gaming machine includes both the door 24 and a corresponding portion of the interior of the gaming machine 20 located behind the door 24. Similarly, while the display 26 is located at a top portion of the door 24 in the embodiment illustrated, there is a corresponding top portion of the interior of the housing 22 located therebehind.

Of course, the gaming machine 20 may have a variety of other configurations and components. For example, the gaming machine 20 may have a top box (not shown) which is located at the top of the cabinet. The top box may be connected to or even be integral with the cabinet.

The gaming machine 20 might also include speakers, a coin acceptor, secondary displays or bonus features and the like. Also, the gaming machine 20 preferably includes at least one gaming controller. The gaming controller may be configured to generate or provide game information and present one or more games via the components of the gaming machine. The gaming controller may be configured to operate in stand-alone fashion, or as connected to a remote controller, such as a remote gaming server or the like. Preferably, the gaming controller is configured to present gaming information on the one or more displays 26, such as images of various indicia (symbols, cards, etc.)

In accordance with the invention, the gaming machine 20 includes a media dispenser 42. In one embodiment, the media dispenser 42 comprises a media printer, such as a printer configured to print ink upon a paper ticket. Of course, the media dispenser 42 might be configured to generate and/or dispense other media, such as magnetic stripe cards or the like.

In a preferred embodiment, the media dispenser 42 comprises a media generator 44, a media transport 46 and a media outlet 48. Preferably, the media dispenser 42 is located at the belly portion 36 of the gaming machine 20, as detailed below.

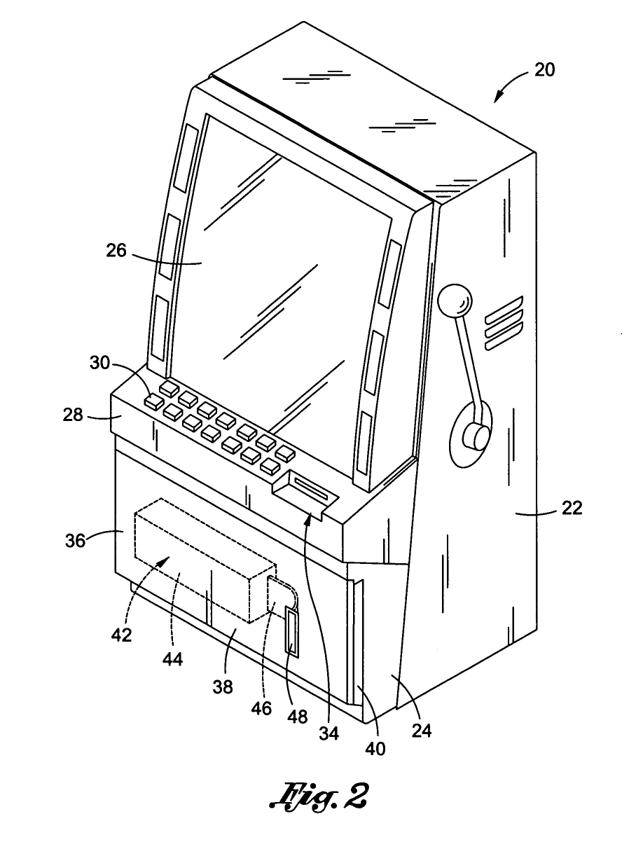

FIGS. 3 and 4 illustrate addition aspects of the invention. As illustrated, the media dispenser 42 is located at the belly portion 36 of the gaming machine 20. Preferably, the media dispenser 42 is located behind the door 24 of the gaming machine 20. In a preferred embodiment in which the door 24 has sufficient depth (as illustrated), the media dispenser 42 is located substantially in a space in front of or forward of the housing 22, and inside a space generally defined by the door 24 (when the door is closed).

In a preferred embodiment, the media generator 44 of the media dispenser 42 has a generally elongate housing and extends horizontally (when considering the longest dimension of the housing). It is possible for the media generator 44 to be located in other orientations, however, especially depending upon the configuration of the dispenser 42.

In an embodiment in which a door or panel 40 is located at the belly portion 36 of the gaming machine 20, the media dispenser 42 is preferably located behind that panel 40. In this manner, the media dispenser 42 may be accessible by opening the panel 40.

In a preferred embodiment of the invention, at least a portion of the media dispenser 42 is located in front of at least a portion of the currency acceptor 34 of the gaming machine 20. As best illustrated in FIGS. 3 and 4, in one embodiment a portion of the currency acceptor 34 is located in front of (i.e. closer to the door 24 or front of the gaming machine) the bill box 52 portion of the currency acceptor 34.

FIGS. 5-7 illustrate one embodiment of a media dispenser 42 in accordance with the invention. As illustrated, the media generator 44 has a generally rectangular housing which is elongate and has a height greater than its width, though the shape thereof may vary. As is known in the art, the media generator 44 preferably houses one or more media, such as a plurality of blank paper tickets. The media generator 44 preferably also houses or supports a media printer, such as an ink printer configured to print information upon paper tickets. Of course, the media generator 44 may be configured to print or otherwise associate a wide variety of information with a media. Such information may comprise numbers, letters, bar codes, magnetically encoded information and the like. The media generator 44 may also be configured to generate media in other manners.

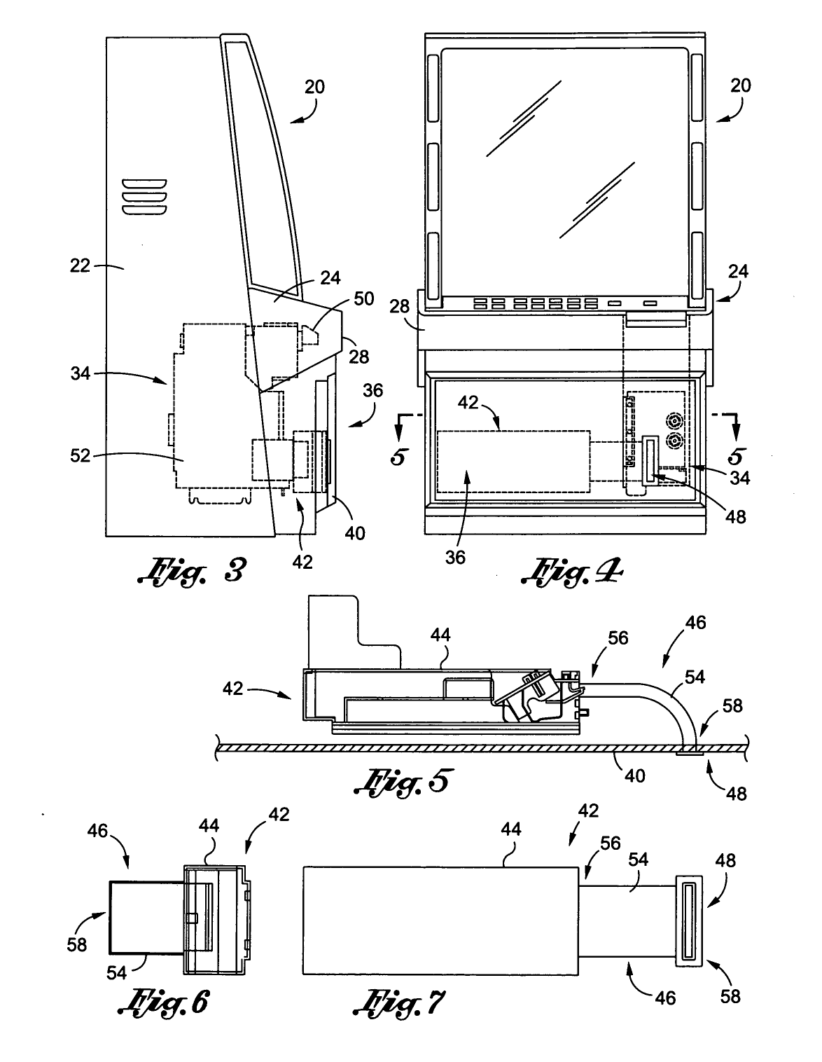

The media transport 46 leads from the media generator 44. The media transport 46 preferably comprises a generally closed chute or conduit 54 through which a media is transported from the media generator 44 to the media outlet 48. In one embodiment, the conduit 54 has a first end 56 connected to the media generator 44 and second end 58 located at the media outlet 48. In one embodiment, the conduit 54 is rectangular in cross-sectional profile, having a front and rear face which are larger in dimension that a top and bottom thereof. Preferably, the conduit 54 defines a narrow, generally rectangular delivery path or slot therethrough, generally similar in shape to the media outlet 48, as illustrated in FIG. 7.

In this embodiment, the media are dispensed from the media dispenser 44 in a generally vertical orientation. In particular, when considering generally planar media such as tickets, the media are dispensed so that faces thereof are oriented vertically (i.e. “on end”). As illustrated, the media transport 46 is similarly oriented, so that each media is delivered in its vertical orientation from the media generator 44 to the media outlet 48, where it is dispensed in the same orientation.

In one embodiment, the media transport 46, and thus the conduit 54, is curved between its ends 56,58. As illustrated, the conduit 54 extends outwardly from the media generator 44 generally parallel to the lengthwise dimension of the media generator 44 (and as detailed below, parallel to the interior of the gaming machine 20 or in a “side to side” direction). However, the conduit 54 bends, preferably at approximately 90 degrees, to its second end 58. Thus, the media transport 46 at the second end 58 is oriented generally perpendicular to the portion of thereof at the first end 56, and perpendicular to the lengthwise dimension of the media generator 44.

In a preferred embodiment, media is dispensed by the media dispenser 42 to a point external to the gaming machine 20. As illustrated in FIG. 5, the media transport 46 preferably extends from the media generator 44 located within the interior of the gaming machine 20, to the panel 40 (or other portion) at the belly portion 36 of the gaming machine 20. The media outlet 48, which preferably comprises a slot or other opening, preferably opens on the outside of the gaming machine 20 (such as through an opening in the door or the panel thereof). In this manner, as detailed below, media may be dispensed to the exterior of the gaming machine 20.

In one embodiment of the invention, as best illustrated in FIGS. 3 and 4, a portion of the media transport 46 and the media outlet 48 are located in front of the currency acceptor 34. As illustrated, in one embodiment, the currency acceptor 34 is located towards one side (the right side, as illustrated in FIG. 4) of the gaming machine 20. The media generator 44 portion of the media dispenser 42 is located towards an opposing side (the left side, as illustrated in FIG. 4) of the gaming machine 20. The media transport 46 extends outwardly from the media generator 44 and extends towards the currency acceptor 34. Preferably, the media transport 46 extends in front of the currency box 52 portion of the currency acceptor 34 in the belly portion 36 of the gaming machine 20. In one embodiment, the media transport 46 extends to a point at which the media outlet 48 is also located in front of the currency acceptor 34, as best illustrated in FIG. 4.

In this embodiment, the larger dimension front and rear faces of the conduit 54 of the media transport 46 are oriented vertically, as is the media outlet or opening 48 (when the outlet is a generally rectangular slot, as illustrated).

FIGS. 8-12 illustrate another embodiment of the invention. In the description and figures of this embodiment, like reference numerals have been utilized to designate like elements to those of the previously described embodiment, except that the designator “a” has been added to the reference numerals designating this embodiment.

This embodiment of the invention is similar to that detailed above, except that the orientation of the media dispenser 42a and the configuration of the media dispenser, vary from that detailed above.

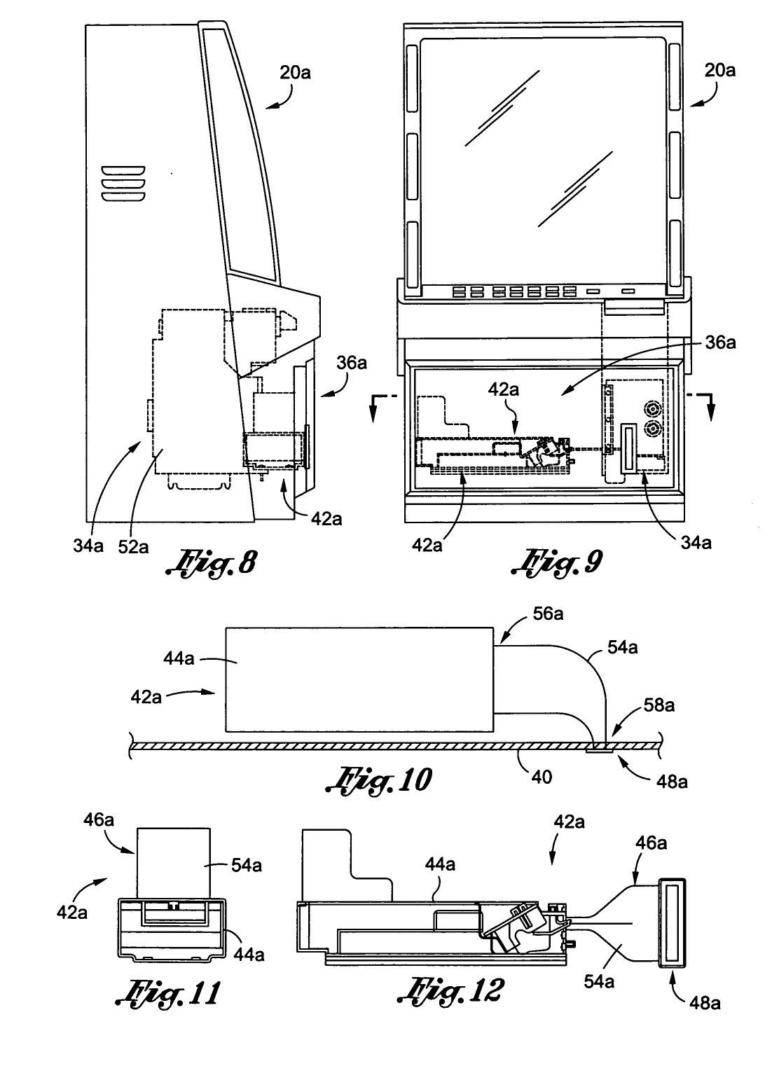

As illustrated in FIGS. 10-12, in this embodiment, the media dispenser 42a again has a media generator 44a, a media transport 46a, and a media outlet 48a. The media transport 46a is again preferably defined by a conduit 54a. A first end 56a of the conduit 54a is located at the body 44a. The second end 58a is again located at the media outlet 48a.

Once again, the conduit 54a extends outwardly from the media generator 44a generally parallel to the lengthwise dimension thereof, and then curves approximately ninety (90) degrees to its second 58. In this embodiment, however, the media generator 44a is oriented so that media are dispensed in a generally horizontal position. It is noted that this embodiment is distinguished from that illustrated in FIGS. 3-7, wherein the media are dispensed in a vertical orientation. In one embodiment, this is accomplished by rotating the media generator 44a ninety (90) degrees from the orientation of the media generator 44 as in the embodiment illustrated in FIGS. 3-7.

In order to accept the horizontally oriented media from the media generator 44a, the first end of the media transport 46a is similarly oriented, as best illustrated in FIGS. 10 and 12. In particular, at the first end 56a, the conduit 54a is arranged so that the larger front and rear faces thereof are oriented horizontally (so that the slot or opening therein in similarly oriented).

Preferably, however, the media is dispensed from the gaming machine 20a to the player in a generally vertical orientation. Thus, as illustrated, the conduit 54a twists between its first and second ends 56a, 58a so that the front and rear faces are generally horizontally extending at the first end 56a, and generally vertically extending at the second end 58a. In other words, the orientation of the media transport 46a changes by ninety (90) degrees in order to redirect the media from a horizontal to a vertical orientation.

As illustrated in FIGS. 8 and 9, the media dispenser 42a is, however, still preferably located at a belly portion 36a of the gaming machine 20a. In similar fashion to that detailed above, a portion of the media transport 46a and the media outlet 48a are again located in front of the currency acceptor 34a, and more particularly, a bill box 52a portion thereof.

In one embodiment, the media dispenser of the invention is mounted to the door of the gaming machine, whereby when the door is opened, the media dispenser moves with the door. In another embodiment, the media dispenser is supported by the housing and the outlet thereof is aligned with a slot or opening in the door (or a panel or portion thereof). In this configuration, when the door is opened, the media dispenser remains fixed in position.

In one embodiment, only a portion of the media transport and the media outlet are located in front of the currency acceptor. However, in other embodiments, other or additional portions of the media dispenser may be located in front of the currency dispenser. For example, if the currency acceptor were located on the opposing side of the gaming machine, only the media generator portion of the media dispenser might be located in front of the currency acceptor.

In a preferred embodiment, the media dispenser is configured to dispense the media in an upright or vertical orientation. In other embodiments, the media could be dispensed in a horizontal orientation or other orientations.

In one embodiment, the media dispenser output is located directly below the currency acceptor input. This configuration has the advantage that the inputs/outputs are all conveniently arranged for the player (i.e. the player does not have to shift positions to access them, and they are located off to the side of the other inputs, such as buttons). In the embodiment illustrated, the inputs/outputs are particularly arranged for right-handed players. Of course, the gaming machine might be configured with the inputs/outputs on the left side thereof, such as for particular benefit of left-handed players.

In a preferred embodiment, the media dispenser comprises a media transport separate from the media generator or housing thereof. In other embodiments, however, the media generator housing or other portion thereof might define the delivery path.

The invention has numerous advantages. First and foremost, the location of the media dispenser allows the media dispenser to be easily accessed for maintenance, service and/or replacement. In particular, when the door of the gaming machine, or the panel of the door, is opened, the media dispenser is in an unobstructed position for access. No other components are located in front of the media dispenser. Moreover, the media dispenser does not extend into the machine into a position in which it is located so close to other components as to be inaccessible.

Thus, when the gaming machine is opened, a service person may easily access the body of the media dispenser for such servicing as inserting new media or tickets to be printed, or servicing of the print head.

Another advantage of the invention is that the location of the media dispenser in the belly portion of the gaming machine frees up space in other more congested areas of the machine. For example, the location of the media dispenser in the belly area frees up space behind the console where space for button wiring, reel controllers and other components is limited.

Particular advantages are realized as a result of: (1) the orientation of the media dispenser; (2) the location of the media dispenser at least partially in front of the currency acceptor; and (3) the location of the media dispenser in the door portion of the cabinet. First, advantages are realized by the generally horizontal orientation of the media dispenser. This orientation prevents the media dispenser from extending upwardly into the more crowded area of the gaming machine behind the console. This orientation also allows the media dispenser to be located in the door portion of the cabinet (which would generally not otherwise be possible because of the depth of the door and interference with the media dispenser extending upwardly into the electronics in the door behind the console).

Second, by locating the media dispenser in the space substantially defined by the door, rather than the cabinet, otherwise un-utilized space is utilized. This again frees up space in the main portion of the cabinet (defined by the housing) for other components.

Lastly, because the media dispenser is located in the belly portion of the machine and in front of the currency acceptor, the media dispenser again utilized space not which is otherwise not usable. As indicated, that location also allows the media dispenser to be readily accessed without interference.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A gaming machine component configuration comprising:
a cabinet comprising a housing having a front and a door located at said front, said cabinet having a top portion, a console portion below said top portion, and a belly portion below said console portion;
one or more player input devices associated with said console portion;
a currency acceptor, said currency acceptor having a currency box, at least a portion of said currency box located in said belly portion of said cabinet; and
a media dispenser, said media dispenser located in said belly portion of said cabinet, wherein at least a portion of said media dispenser is located in front of said currency box of said currency acceptor.

2. The gaming machine in accordance with claim 1 wherein said currency acceptor further comprises a currency accepting slot located at said console portion and wherein an outlet of said media dispenser is located below said slot in general vertical alignment therewith.

3. The gaming machine in accordance with claim 1 wherein said media dispenser comprises a media generator, a media outlet, and a media transport extending between said media generator and said media outlet.

4. The gaming machine in accordance with claim 3 wherein said media transport comprises a conduit defining a vertically oriented slot and wherein said outlet comprises a corresponding vertically oriented slot, whereby media are dispensed in a vertical orientation.

5. The gaming machine in accordance with claim 3 wherein said media transport extends in front of said currency box of said currency acceptor.

6. The gaming machine in accordance with claim 1 wherein said media dispenser is located in a space behind said door and forward of said housing.

7. The gaming machine in accordance with claim 1 wherein said media dispenser is located behind a panel of said door at said belly portion of said cabinet.

8. The gaming machine in accordance with claim 1 wherein said media dispenser is oriented so that a lengthwise dimension thereof extends generally horizontally.

9. The gaming machine in accordance with claim 1 wherein said door has a belly portion corresponding to said belly portion of said cabinet, and wherein an opening is located in said door corresponding to an outlet of said media dispenser.

10. A gaming machine component configuration comprising:
a cabinet comprising a housing having a front and a door located at said front, said cabinet having a top portion, a console portion below said top portion, and a belly portion below said console portion;
at least one gaming controller configured to provide game information;
at least one display located above said console portion of said cabinet; said at least one display configured to present game information provided by said at least one gaming controller; and
a media dispenser, said media dispenser located in said belly portion of said cabinet behind said door and forward of said housing.

11. The gaming machine in accordance with claim 10 wherein said door has a depth and said media dispenser is substantially within said depth of said door when said door is in a closed position relative to said housing.

12. The gaming machine in accordance with claim 10 wherein said media dispenser comprises a media generator having an elongate housing, a lengthwise dimension of said housing oriented horizontally.

13. The gaming machine in accordance with claim 12 wherein said media generator is oriented to dispense media in a horizontal orientation.

14. The gaming machine in accordance with claim 13 wherein said media dispenser further comprises a media transport, said media transport configured to change the orientation of media dispensed from said media generator to a vertical orientation.

15. The gaming machine in accordance with claim 10 wherein said media dispenser extends from a first side laterally across said belly portion of said cabinet towards a second side thereof.

16. The gaming machine in accordance with claim 10 wherein at least a portion of said media dispenser is mounted to said door.

17. The gaming machine in accordance with claim 10 wherein said media dispenser comprises a media generator and a media transport, said media transport leading from said media generator to a media outlet.

18. The gaming machine in accordance with claim 17 wherein said media transport has a first end oriented in a first direction and a second end oriented in a second direction, said second direction being offset approximately ninety degrees from said first direction.

19. The gaming machine in accordance with claim 17 wherein said media outlet comprises a vertically oriented slot.
